(19) United States
(12) Patent Application Publication
(10) Pub. No.: US 2012/0078143 A1
(43) Pub. Date: Mar. 29, 2012

(54) VIBRATING PACIFIER

(76) Inventors: Sergio Hernandez, Cape Coral, FL (US); Laura Geimann, Cape Coral, FL (US)

(21) Appl. No.: 12/889,446

(22) Filed: Sep. 24, 2010

(51) Int. Cl. A61J 17/00; A61H 1/00

(52) U.S. Cl. 601/46; 606/236

(57) ABSTRACT

A vibrating pacifier comprising a housing, where the housing encompasses a vibrating mechanism, a set of wings extending from opposing sides of the housing, a nipple protruding from the housing, where the nipple is covered in a plurality of nubs on a blunt end of the nipple, and a handle attached to the housing, wherein the handle contains a battery compartment and a switch to activate the vibrating mechanism to enable the vibrating pacifier to oscillate thus providing comfort and relief to a baby while teething.

### BACKGROUND OF THE INVENTION

1. Field of the Invention

The present invention relates to a pacifier comprising a vibrating mechanism to enable the pacifier to vibrate and pulse when activated, and a nipple with a plurality of nubs to sooth the gums of baby while they are teething.

2. Description of Related Art

A common accessory associated for babies is a pacifier. Pacifiers are used as a device for the baby to suck on or chew as a way to comfort them and/or sooth their sore gums. Babies find the sucking actions calming and may associate it with their mother, so the baby may calm itself when sucking on the pacifier. Parents understand that when a baby is developing new teeth, the baby's mouth and gums must endure a great deal of discomfort and pain. Many times the gums feel overwhelmingly itchy when new teeth are breaking through and the baby acts out by crying, drooling and sometimes not sleeping or eating. The pacifiers are meant to rub against the sore gums to relieve the intense itch and ache, thus enabling greater comfort and calm to not only the baby but the parents as well.

A problem with many of the pacifiers is that most are simply a piece of plastic with a rubber nipple. While some pacifiers are available with a textured nipple to rub against the gums, pacifiers normally don't offer any further special features to help relieve sore gums and teeth for when a baby is teething. The baby may chew on the textured nipple for comfort but the pacifier does not actively perform any actions to sooth the baby's painful gums.

It would be beneficial in the art to provide a pacifier with a combination of additional features to sooth and relieve a baby. It would also be desirable to have a pacifier which does not fall to the ground when dropped or spit out by the baby.

### SUMMARY OF THE INVENTION

The present invention provides a vibrating pacifier comprising a housing, where the housing encompasses a vibrating mechanism, a set of wings extending from opposing sides of the housing, a nipple protruding from the housing, where the nipple is covered in a plurality of nubs on a blunt end of the nipple, and a handle attached to the housing, wherein the handle contains a battery compartment and a switch to activate the vibrating mechanism to enable the vibrating pacifier to oscillate thus providing comfort and relief to a baby while teething.

The present invention further includes a strap or leash to connect the vibrating pacifier to a shirt or apparatus to prevent the baby from dropping or losing the vibrating pacifier during use.

These together with other aspects of the present invention, along with the various features of novelty that characterize the present invention, are pointed out with particularity in the claims annexed hereto and form a part of this present invention. For a better understanding of the present invention, its operating advantages, and the specific objects attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawings, wherein like elements are identified with like symbols, and in which:

FIG. 1 depicts a perspective view of a vibrating pacifier in accordance with an exemplary embodiment of the present invention, and

FIG. 2 depicts a backside view of a handle in accordance with an exemplary embodiment of the present invention.

Like reference numerals refer to like parts throughout the description of several views of the drawings.

### DETAILED DESCRIPTION OF THE DRAWINGS

The present invention relates to a pacifier used to comfort a baby and sooth sore gums for when the baby is teething. The vibrating pacifier is a portable teething device, equipped with a vibrating mechanism within a main housing. The vibrating mechanism oscillates the nipple of the vibrating pacifier within the baby's mouth to provide itch and irritation relief, symptoms commonly associated with teething. The nipple also has a plurality of nubs or bums to provide a greater itch relieving texture on the surface of the baby's gums.

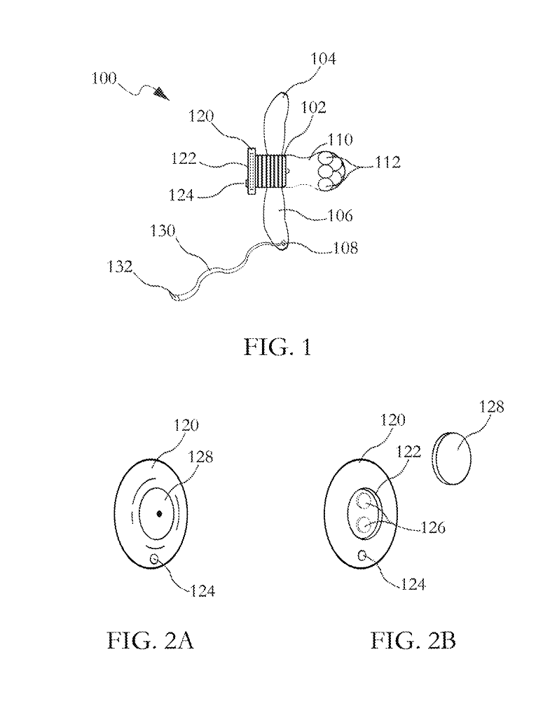

Turning now descriptively to the drawings, referring to FIG. 1, a perspective view of a vibrating pacifier (100) is shown in accordance with an exemplary embodiment of the present invention. The vibrating pacifier (100) may include a housing (102), a set of wings (104 and 106), a nipple (110) and a handle (120). The set of wings (104 and 106) attach to the housing (102) and may extend laterally from the housing (102) to rest comfortably against each side of a mouth or a pair of cheeks of a baby. The set of wings (104 and 106) may be made from a bendable plastic or rubber material for a gentle fit against the baby's face. Extending from the housing (102) is the nipple (110). The nipple (110) may be anatomically shaped to fit accordingly against the contours of the baby's mouth, and made from a silicone or soft rubber material for additional comfort. Also, the nipple (110) may be detached and replaced with another nipple, of a same or differing size, to enable more than one nipple to be exchanged on the housing (102), thus the same housing (102) may be used for a plurality of nipples (110). Surrounding an outer covering on a blunt end of the nipple (110), opposite from the housing (102), are a plurality of nubs (112), bumps or bubbles. The nubs (112) may provide a textured and pleasant surface for the baby to chew on while they are teething. The feeling of the nubs (112) against the baby's gums may sooth and relieve the baby's discomfort when new teeth are budding.

The handle (120) is attached to a backside of the housing (102). The handle (120) may house a battery compartment (122) with a button (124) situated above the battery compartment (122). The housing (102) provides a means to shelter a vibrating mechanism which activates when the button (124) is pressed. The vibrating mechanism is a small motor which may enable the vibrating pacifier (100) to pulse, vibrate or oscillate when activated. The oscillating motions of the vibrating pacifier (100) may sooth and relax the baby to alleviate the pain associated when teething.

In one exemplary embodiment, a receiving hole (108) may be provide on the wing (106). The strap (130) threads through the receiving hole (108) to enable the vibrating pacifier (100) to attach to clothing or a structure. The strap (130) may be made of elastic, ribbon, cloth or another type of material to act as a leash for the vibrating pacifier (100). The strap (130) may be available in multiple colors and patterns to match the clothing or accessories worn by the baby. At an opposite end from the receiving hole (108), the strap (130) has an attachment means (132). The attachment means (132) may be a strip of Velcro, a button, a snap, a rubber band or a clip to secure the vibrating pacifier (100) a bib, shirt, wrist, car seat, bouncer, highchair or various other devices to carry the baby. The strap (130) and the attachment means (132) provide a means to prevent the vibrating pacifier from getting lost or falling to the floor in case the baby spits it out or loses their grip.

Referring to FIGS. 2(A) and 2(B), a backside view of the handle (120) is shown in accordance with an exemplary embodiment of the present invention. FIG. 2 (A) shows the handle (120) in an open configuration, whereas FIG. 2(B) shows the handle (120) in a closed configuration. In FIG. 2(A), the handle (120) includes a cap (128) to cover the battery compartment (122). The cap (128) may snap or screw onto the handle (120) to protect an underlying set of batteries (126). The batteries (126) permit the vibrating mechanism within the housing (102) to continuously move for long lasting enjoyment and comfort by the baby. The vibrating pacifier (100), including the strap (130), may be placed in a case or container so that a parent may simply place the device and all of its contents into a diaper bag or purse for easy transportation. The case helps to keep the vibrating pacifier (100) clean during transport and my hold any extra batteries in case a battery dies and needs to be replaced.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. A vibrating pacifier for a baby or infant comprising:
a housing, where said housing encompasses a vibrating mechanism;
a set of wings extending from opposing sides of said housing;
a nipple protruding from said housing; and
a handle attached to said housing, wherein said handle includes a battery compartment and a switch to activate said vibrating mechanism to enable said vibrating pacifier to oscillate.

2. The vibrating pacifier according to claim 1, where said nipple is covered in a plurality of nubs on a blunt end of said nipple.

3. The vibrating pacifier of claim 1, wherein said handle includes a cap to secure a battery within said battery compartment.

4. The vibrating pacifier of claim 1, wherein one wing of said set of wings includes a receiving hole to accept a strap with an attachment means at an opposing end from said receiving hole.

5. The vibrating pacifier of claim 3, wherein said attachment means is a Velcro strip, a clip or a snap.

6. The vibrating pacifier of claim 1, wherein said nipple has an anatomical shape to fit properly within a mouth of said baby.
